(19) United States
(12) Patent Application Publication
(10) Pub. No.: US 2017/0242311 A1
(43) Pub. Date: Aug. 24, 2017

(54) LAYOUT METHOD FOR DISPLAY PANEL AND GOA CIRCUIT AND DISPLAY PANEL

(71) Applicants: Yafeng LI, Wuhan, Hubei (CN); Xiangyi PENG, Wuhan, Hubei (CN)

(72) Inventors: Yafeng LI, Wuhan, Hubei (CN); Xiangyi PENG, Wuhan, Hubei (CN)

(21) Appl. No.: 14/907,122

(22) PCT Filed: Jan. 13, 2016
(86) PCT No.: PCT/CN2016/070809

§ 371 Date: Jan. 22, 2016

(30) Foreign Application Priority Data
Dec. 28, 2015 (CN) 201511005163.X

(51) Int. Cl. G02F 1/1362; G02F 1/133; G09G 3/36

(52) U.S. Cl. CPC G02F 1/136204; G09G 3/3677; G02F 1/136286; G02F 1/13306; G09G 2330/04

(57) ABSTRACT

The present invention relates to a display panel having a plurality of GOA circuits and an image display area. The image display area has a plurality of pixel units. The display panel further includes a plurality of tilted wiring channels configured for connecting the plurality of GOA circuits to the plurality of corresponding pixel units, respectively.

### FIELD OF THE INVENTION

The present invention relates to a display panel technology, particularly to a display panel having GOA circuits and a layout method for a display panel.

### BACKGROUND OF THE INVENTION

Liquid crystal display array panel is mainly constructed of an image display area (called “AA” area) and peripheral circuits. For the same type of pixels per inch (PPI), a space size of an image display area is basically fixed so that the design of the space utilized by the peripheral circuits is very important. GOA (gate driver on array) circuits are the largest part in the peripheral circuits, as being an important part connected to the peripheral circuits and the image display area, for controlling the image display area to work, normally. Thus, the space design of the GOA circuits largely affects the efficient usage of the periphery. FIG. 1A illustrates a schematic diagram of a reciprocally-charging type layout of GOA circuits and electrostatic discharge circuits in a conventional display panel. FIG. 1B illustrates a schematic diagram of an interlaced type layout of GOA circuits and electrostatic discharge circuits in a conventional display panel. The differences between both of the types are that in the reciprocally-charging type layout, the GOA circuit and the electrostatic discharge circuit of the same stage are divided into a left part and a right part, the left-and-right parts which are symmetrically arranged on two sides of the display panel 1, as the GOA circuits including GOA_L1 and GOA_R1, GOA_L2 and GOA_R2, and the electrostatic discharge circuits ESD_LU and ESD_RU, ESD_LD and ESD_RD shown in FIG. 1A; however, in the interlaced type layout, the odd stage GOA circuits and the even stage GOA circuits are respectively arranged on the left side and the right side of the display panel 1, as shown in FIG. 1B where GOA_1 and GOA_3 are laid on the left side, GOA_2 and GOA_4 are laid on the right side, and the electrostatic discharge circuits are structurally similar to ESD_LU and ESD_RU, ESD_LD and ESD_RD shown in FIG. 1A, except that the positions of the electrostatic discharge circuits are arranged asymmetrical. As shown in FIG. 1A and 1B, a longitudinal space where the conventional GOA circuits are arranged exceeds a longitudinal length of the image display area 10, and thus the electrostatic discharge circuits (used for protecting the GOA circuits) at four corners can only be laid in the corner area far away from the image display area 10. Because the image display area 10 includes a plurality of pixel units 11, such a faraway layout is not helpful for the electrostatic discharge circuits protecting the image display area 10, and also affects the translucency of the peripheral space, and on the corner area the seal coated on the electrostatic discharge circuits is likely to peel.

Therefore, it is necessary to provide a layout method for a GOA circuit and an electrostatic discharge circuit to efficiently use the space.

### SUMMARY OF THE INVENTION

To improve the layout of the GOA circuits on the display panel, and efficiently use the space, a display panel is provided according to an preferred embodiment of the present invention, having a plurality of GOA circuits and an image display area (AA area), the image display area having a plurality of pixel units, wherein the display panel further includes a plurality of tilted wiring channels, formed for connecting the plurality of GOA circuits to the plurality of corresponding pixel units, respectively.

Preferably, the display panel further includes a plurality of electrostatic discharge circuits (ESD), along with the plurality of GOA circuits, disposed in a space having a length equal to a length of a longitudinal side of the image display area.

Preferably, a length of each of the plurality of tilted wiring channels is proportional to a distance from a middle position of the image display area to a position where a gate terminal of the corresponding respective pixel unit is located.

Preferably, an absolute value of a slope of each of the plurality of tilted wiring channels is proportional to a distance from a middle position of the image display area to a position where a gate terminal of the corresponding respective pixel unit is located.

According to the embodiment of the present invention, the present invention provides a layout method for a display panel, including the following steps: respectively connecting the plurality of GOA circuits to the plurality of corresponding pixel units through a plurality of tilted wiring channels.

Preferably, the layout method further includes: disposing the plurality of GOA circuits and the plurality of electrostatic discharge circuits (ESD) in a space having a length equal to a length of a longitudinal side of the image display area.

Preferably, the layout method further includes the following step of: making a length and an absolute value of a slope of each of the plurality of tilted wiring channels to be proportional to a distance from a middle position of the image display area to a position where a gate terminal of the corresponding respective pixel unit is located.

The layout of the display panel of the present invention is helpful for the electrostatic discharge circuits protecting the image display area, thereby increasing the translucency of the peripheral space of the image display area, reducing the peeling of the seal, and increasing the performance and yield of the product.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a schematic diagram of a reciprocally-charging type layout of GOA circuits and electrostatic discharge circuits of a conventional display panel;

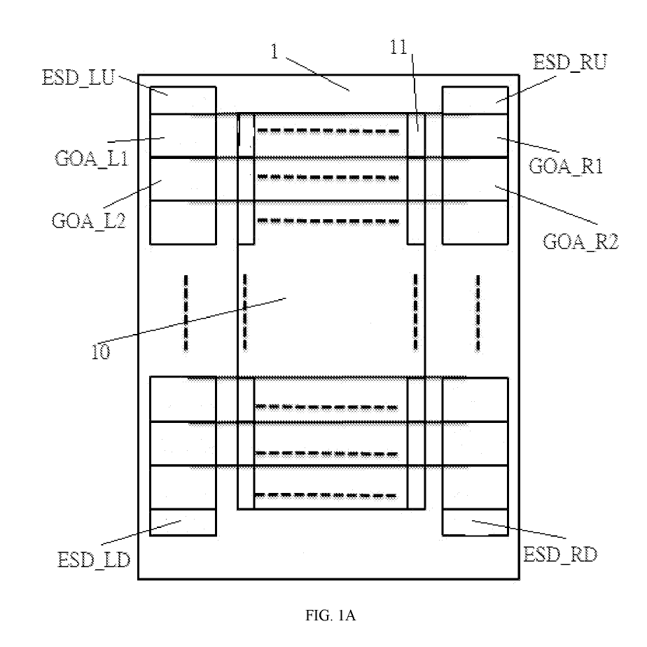

FIG. 1B illustrates a schematic diagram of an interlaced type layout of GOA circuits and electrostatic discharge circuits of a conventional display panel;

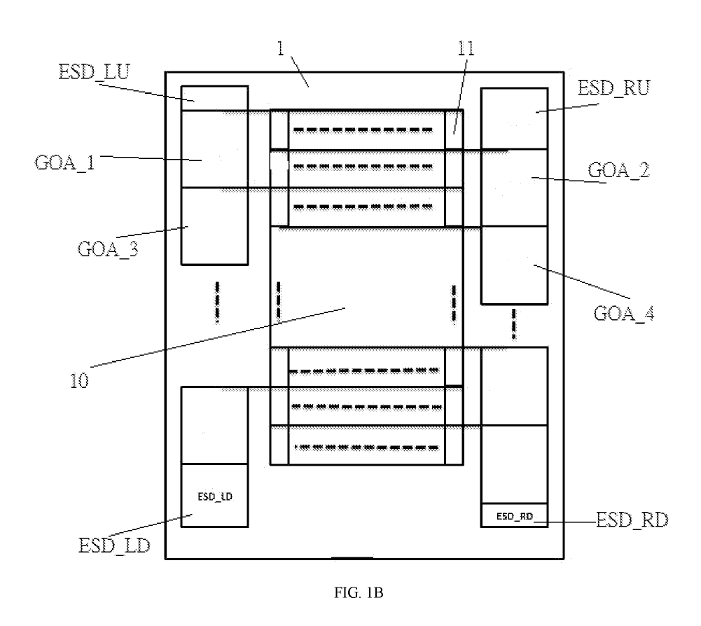

FIG. 2A illustrates a schematic diagram of a reciprocally-charging type layout of GOA circuits and electrostatic discharge circuits according to a preferred embodiment of the present invention;

FIG. 2B illustrates a schematic diagram of an interlaced type layout of GOA circuits and electrostatic discharge circuits according to a preferred embodiment of the present invention; and

FIG. 3 illustrates a flowchart of a layout method of GOA circuits and electrostatic discharge circuits according to a preferred embodiment of the present invention.

### DETAILED DESCRIPTION OF THE PREFERRED EMBODIMENTS

As used in this specification the term “embodiment” means an instance, example, or illustration. In addition, for the articles in this specification and the appended claims, “a” or “an” in general can be interpreted as “one or more” unless specified otherwise or clear from context to determine the singular form.

In the drawings, the same reference numerals denote units with similar structures.

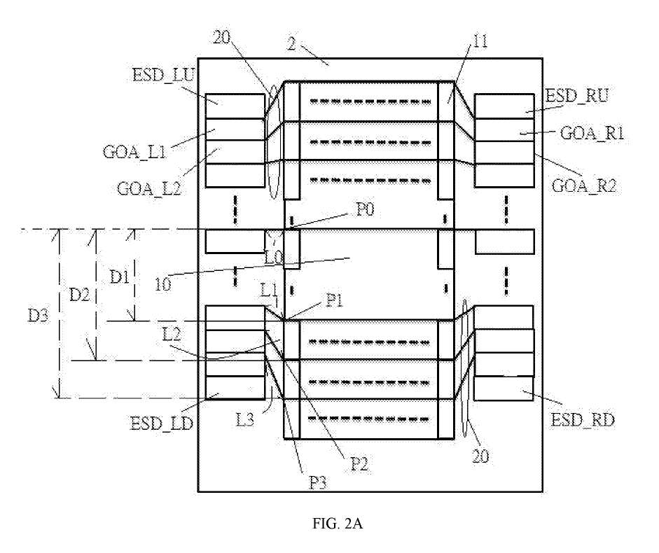

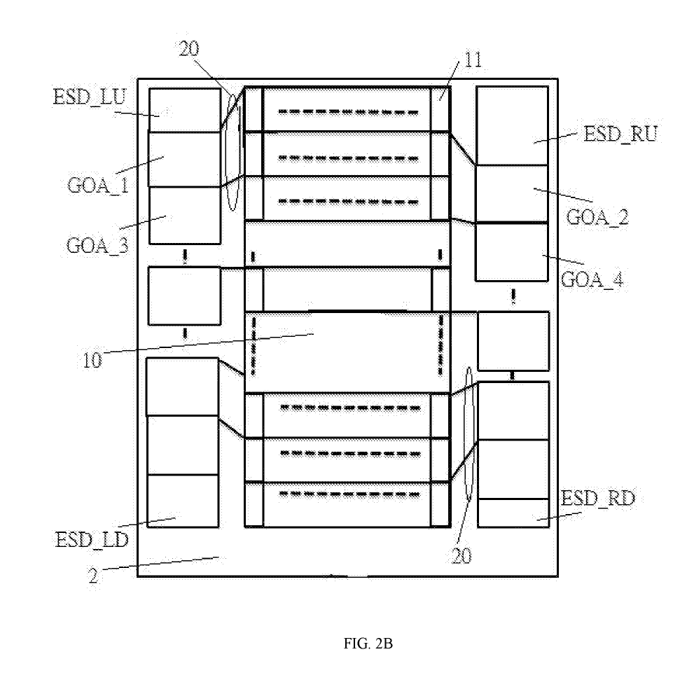

Please refer to FIG. 2A and 2B. FIG. 2A illustrates a schematic diagram of a reciprocally-charging type layout of GOA circuits and electrostatic discharge circuits of a display panel 2 according to a preferred embodiment of the present invention. FIG. 2B illustrates a schematic diagram of an interlaced type layout of GOA circuits and electrostatic discharge circuits of a display panel 2 according to a preferred embodiment of the present invention. Each type of display panel 2 has a plurality of GOA circuits and an image display area (as called “AA” area) 10, the differences between the two types of the layouts are that: in the reciprocally-charging type layout, the GOA circuits and the electrostatic discharge circuits of the same stage are divided into a left part and a right part, both parts which are symmetrically arranged on two sides of the display panel 2 in a lateral position, as the left and right GOA circuits GOA_L1 and GOA_R1, GOA_L2 and GOA_R2, the left and right electrostatic discharge circuits ESD_LU and ESD_RU, ESD_LD and ESD_RD shown in FIG. 2A; however, in the interlaced type layout, the odd stage GOA circuits and the even stage GOA circuits are respectively arranged on the left side and the right side of the display panel 2, as shown in FIG. 2B where GOA_1 and GOA_3 are laid on the left side of the display panel 2, GOA_2 and GOA_4 are laid on the right side of the display panel 2, but the arrangement position of the electrostatic discharge circuits ESD_LU and ESD_RU, ESD_LD and ESD_RD in FIG. 2B are similar to ESD_LU and ESD_RU, ESD_LD and ESD_RD in FIG. 2A.

Please further refer to FIGS. 2A and 2B. The image display area 10 has a plurality of pixel units 11, the display panel 2 further includes a plurality of tilted wiring channels 20, each of the GOA circuits (namely, GOA_1, GOA_2 or GOA_L1 and GOA_R1, GOA_L2, and GOA_R2 etc.) is electrically and obliquely coupled to a gate terminal (P1, P2, P3 . . . ) of each corresponding pixel unit 11 in the image display area 10 by the respective tilted wiring channel 20; in this way, the layout space can be compressed, and the electrostatic discharge circuits at port can be thus near to the image display area 10 as possible. Furthermore, each of the electrostatic discharge circuits (ESD_LU and ESD_RU, ESD_LD and ESD RD) along with each of the GOA circuits (GOA_1, GOA_2, etc., or GOA_L1 and GOA_R1, GOA_L2 and GOA_R2, etc.) are disposed in a space having a length equal to a length of a longitudinal side of the image display area 10. Meanwhile, the layouts of the plurality of tilted wiring channels 20 can be improved by accompanying the layout positions of the electrostatic discharge circuits (ESD_LU and ESD_RU, ESD_LD and ESD_RD) and the GOA circuits (that is, GOA_1, GOA_2, etc., or GOA_L1 and GOA_R1, GOA_L2 and GOA_R2, etc.), in order to further improve the efficiency of using the space of the overall layout. Preferably, as shown in FIG. 2A, if a shortest distance L0 from a middle position P0 of the image display area 10 to which one of the tilted wiring channels 20 is nearest to the middle position P0 (which is not necessarily as the connecting length of the tilted wiring channel 20) is treated as a reference length, a length of each of the plurality of tilted wiring channels 20 (L1, L2, L3 . . . ) is proportional to a distance (D1, D2, D3 . . . ) from a middle position P0 of the image display area 10 to a position (P0, P1, P2, P3 . . . ) of a gate terminal of the corresponding pixel unit 11 where the respective tilted wiring channel 20 is connected. In other words, the length of the respective tilted wiring channel 20 is shorter while the respective tilted wiring channel 20 is nearer to the middle position P0 of the image display area 10, and vice versa, the length of the length of the respective tilted wiring channels 20 is longer while the respective tilted wiring channels 20 is farther away from the middle position P0 of the image display area 10. Alternatively, if a shortest distance L0 from a middle position P0 of the image display area 10 to which one of the tilted wiring channels 20 is nearest to the middle position P0 is treated as a reference length, an absolute value of a slope of the respective tilted wiring channel 20, for example, corresponding respectively to the respective tilted wiring channel 20 with lengths (L1, L2, L3) is |D1/L0|, |D2/L0|, |D3/L0|, and all are proportional to a distance (D1, D2, D3 . . . ) from a middle position P0 of the image display area 10 to a position (P0, P1, P2, P3 . . . ) of a gate terminal of the corresponding pixel unit 11 where the respective tilted wiring channel 20 is connected. In other words, the absolute value of the slope of the respective tilted wiring channels 20 is smaller while the respective tilted wiring channels 20 is nearer to the middle position P0 of the image display area 10, and vice versa, the absolute value of the slope of the respective tilted wiring channel 20 is larger while the respective tilted wiring channels 20 is farther away from the middle position P0 of the image display area 10.

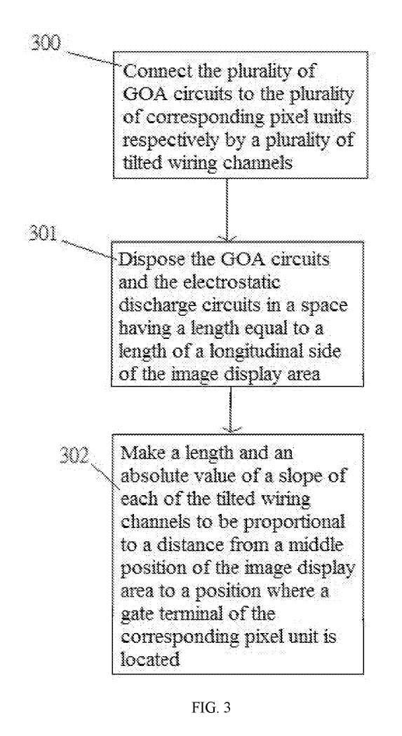

Please refer to FIG. 3, which illustrates a flowchart of a layout method of GOA circuits and electrostatic discharge (ESD) circuits according to a preferred embodiment of the present invention. To more clearly understand the layout method, FIG. 2A and 2B can be accompanied with the following descriptions for the method steps. As shown in FIG. 3, in step 300, the plurality of GOA circuits are connected to the plurality of corresponding pixel units respectively by a plurality of tilted wiring channels; in step 301, the plurality of GOA circuits and the plurality of electrostatic discharge circuits are disposed in a space having a length equal to a length of a longitudinal side of the image display area. Preferably, the layout method further includes a step 302 of making a length and an absolute value of a slope of each of the plurality of the tilted wiring channels to be proportional to a distance from a middle position of the image display area to a position where a gate terminal of the corresponding pixel unit is located.

The layout of the display panel 2 according to the present invention is helpful for the electrostatic discharge circuit protecting the image display area 10, increasing the translucency of the peripheral space of the image display area, reducing the peeling of the seal, and increasing the performance and yield of the product.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

1. (canceled)

2. A display panel, having a plurality of GOA circuits and an image display area, the image display area having a plurality of pixel units, wherein the display panel further comprises:
a plurality of tilted wiring channels, formed for connecting the plurality of GOA circuits to the plurality of corresponding pixel units, respectively.

3. The display panel of claim 2, wherein the display panel further comprises:
a plurality of electrostatic discharge circuits, along with the plurality of GOA circuits, disposed in a space having a length equal to a length of a longitudinal side of the image display area.

4. The display panel of claim 2, wherein a length of each of the plurality of the tilted wiring channels is proportional to a distance from a middle position of the image display area to a position where a gate terminal of the corresponding respective pixel unit is located.

5. The display panel of claim 2, wherein an absolute value of a slope of each of the plurality of tilted wiring channels is proportional to a distance from a middle position of the image display area to a position where a gate terminal of the corresponding respective pixel unit is located.

6. A GOA circuit, located in a display panel, the display panel having at least one electrostatic discharge circuit and an image display area, the image display area having at least one pixel unit, wherein the GOA circuit is connected to a gate terminal of the at least one pixel unit through a tilted wiring channel.

7. The GOA circuit of claim 6, wherein the GOA circuit and the at least one electrostatic discharge circuit all are disposed in a space having a length equal to a length of a longitudinal side of the image display area.

8. The GOA circuit of claim 6, wherein a length and an absolute value of a slope of each of the plurality of the tilted wiring channels are proportional to a distance from a middle position of the image display area to a position where a gate terminal of the corresponding respective pixel unit is located.

9. A layout method for a display panel which has a plurality of GOA circuits, a plurality of electrostatic discharge circuits and an image display area, wherein the layout method comprises the following step of:
respectively connecting the plurality of GOA circuits to the plurality of corresponding pixel units, through a plurality of tilted wiring channels,

10. The layout method of claim 9, further comprising the following step of:
disposing the plurality of GOA circuits and the plurality of electrostatic discharge circuits in a space having a length equal to a length of a longitudinal side of the image display area.

11. The layout method of claim 9, further comprising the following step of:
making a length and an absolute value of a slope of each of the plurality of the tilted wiring channels to be proportional to a distance from a middle position of the image display area to a position where a gate terminal of the corresponding respective pixel unit is located.
